(19) United States
(12) Patent Application Publication
(10) Pub. No.: US 2009/0146943 A1
(43) Pub. Date: Jun. 11, 2009

(54) LIGHT SOURCE MODULE, DISPLAY DEVICE HAVING THE SAME, AND A METHOD THEREOF

(75) Inventors: Hyuk-Hwan KIM, Asan-si (KR); Chi-O CHO, Asan-si (KR); Seon-Bae KIM, Asan-si (KR); Seok-Hyun NAM, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/254,744

(22) Filed: Oct. 20, 2008

(30) Foreign Application Priority Data
Dec. 10, 2007 (KR) 1020070127509

(51) Int. Cl. G09G 3/34; G09G 3/36

(52) U.S. Cl. 345/102; 345/103

(57) ABSTRACT

A light source module includes a plurality of light source units arranged in a matrix form and independently emitting light, and a light source control unit. The light source control unit includes a column control unit supplying a column control signal to a plurality of light source unit columns according to a brightness signal, a row control unit supplying a row control signal to a plurality of light source unit rows according to the brightness signal, and a brightness regulation unit supplying the brightness control signal to the column control unit and the row control unit. The plurality of light source units successively emit light for one frame in a light source column direction or a light source row direction, according to the brightness signal, the column control signal and the row control signal.

This application claims the benefit of priority to Korean Patent Application No. 10-2007-0127509 filed on Dec. 10, 2007, and all the benefits accruing therefrom under 35 U.S.C. §119, the contents of which are incorporated by reference in their entirety.

### BACKGROUND OF THE INVENTION

1. Field of the Invention

The present invention relates to a light source module and a display device having the same, and more particularly, to a light source module including a plurality of light source units arranged in a matrix form, independently emit light according to the brightness of a screen corresponding to the light source units, and successively emit light in a row or column direction for one frame, respectively, whereby power consumption can be reduced.

2. Description of the Related Art

A liquid crystal display (“LCD”) panel, which is a flat display panel, is not a light emitting device but a light receiving device. Therefore, the light receiving device such as the LCD panel displays images using light supplied from a separate light source module, such as a backlight. The light source module may include a light source, and a light source driving unit for driving the light source.

### BRIEF SUMMARY OF THE INVENTION

Since a flat display panel, such as a liquid crystal display (“LCD”) panel, requires a separate light source to provide light to the display panel, there are disadvantages in displaying images and in operating the display panel. For example, the light source may constantly or evenly supply light having a substantially uniform luminance to an entire surface of the display panel, thereby degrading a contrast ratio of the display panel. The contrast ratio of the display panel may be degraded because the light source supplies the display panel with the light having predetermined luminance, thereby causing light leakage even when the display panel displays images corresponding to black images. Moreover, the light source consumes a relatively large portion of the power in the display panel. Since a conventional light source is turned on and off together with a driving of the display panel, it is difficult to reduce an overall power consumption of the light source.

An exemplary embodiment provides a light source module, a driving method of the light source module, and a display device including the light source module. A brightness of light outputted from a plurality of the light source units, which independently emit light, is controlled according to images of corresponding regions of a display panel of the display device, to thereby improve a contrast ratio. The light source units emit light in a row or column direction for one frame period according to the images of the corresponding blocks, to thereby reduce power consumption,

An exemplary embodiment provides a light source module, which can reduce or prevent discharge interference that may occur when a plurality of light source units are manufactured with a surface light source region divided, a driving method of the light source module, and a display device including the light source module.

In an exemplary embodiment, there is provided a light source module including a plurality of light source units arranged in a matrix form and independently emitting light, and a light source control unit. The light source control unit includes a column control unit supplying a column control signal to each of a plurality of light source unit columns according to a brightness signal, a row control unit supplying a row control signal to each of a plurality of light source unit rows according to the brightness signal, and a brightness regulation unit supplying the brightness signal to the column control unit and the row control unit. The plurality of light source units successively emit light for one frame in any one of a light source unit column direction and a light source unit row direction according to the brightness signal, the column control signal and the row control signal.

The column control signal may be successively supplied to the plurality of light source unit columns and the row control signal may be supplied to the plurality of light source unit rows at substantially the same time. Alternatively, the column control signal may be supplied to the plurality of light source unit columns at substantially the same time and the row control signal may be successively supplied to the plurality of light source unit rows.

Each of the plurality of light source units may include a positive terminal, a negative terminal, and a light source emitting light by a voltage difference between the positive and negative terminals. The positive terminals of the light source units within each the light source unit column may be electrically connected to each other, and the negative terminals of the light source units within each of the light source unit rows may be electrically connected to each other.

The light source module may further include a plurality of column control lines connecting the positive terminals of the respective light source unit columns to the column control unit, and a plurality of row control lines connecting the negative terminals of the respective light source unit rows to the row control unit.

The plurality of column control lines may include a plurality of column extension lines connected to the column control unit and extending in column directions, and a plurality of column connection lines connecting the positive terminals in the light source unit columns to the column extension lines, and the plurality of row control lines may include a plurality of row extension lines connected to the row control unit and extending in row directions, and a plurality of row connection lines connecting the negative terminals in the light source unit rows to the row extension lines.

The plurality of column control lines may include a plurality of column connection lines connecting adjacent positive terminals to each other in the light source unit columns, and the plurality of row control lines may include a plurality of row connection lines connecting adjacent negative terminals to each other in the light source unit rows.

The column control unit may include a plurality of column inverters respectively connected to the plurality of column control lines, and the row control unit may include a plurality of row inverters respectively connected to the plurality of row control lines.

The light source unit may be selected from the group including, but not limited to, a light emitting diode and a xenon lamp.

An exemplary embodiment provides a light source module, which includes a light source unit and a light source control unit. The light source unit includes a light emission plate including a plurality of discharge regions arranged substantially in a matrix form and separated from each other, a plurality of upper electrodes provided over the discharge regions, and a plurality of lower electrodes provided under the discharge regions. The upper electrodes are electrically connected in column directions of the discharge regions, and the lower electrodes are electrically connected in row directions of the discharge regions, The light source control unit supplies a column control signal to each upper electrode column including the upper electrodes connected in the column directions, and supplies a row control signal to each lower electrode row including the lower electrodes connected in the row directions.

Each of the plurality of upper electrodes may be disposed on a top surface of the light emission plate corresponding to the discharge regions, each upper electrode column including more than one upper electrode extended in the column direction, and the more than one upper electrode is separated from each other. Each of the plurality of lower electrodes may be disposed on a bottom surface of the light emission plate corresponding to the discharge region, each lower electrode row including more than one lower electrode arranged in the row direction, and the more than one lower electrode being separated from each other.

A plane size of each of the upper electrodes and the lower electrodes may be equal to or smaller than the discharge region in plane size.

The light source unit may further include a plurality of column control lines electrically connecting the upper electrodes in each upper electrode column, and a plurality of row control lines electrically connecting the lower electrodes in each lower electrode row.

The plurality of discharge regions may be separated by a row separation space and a column separation space, at least a portion of the column control lines and the row control lines may be positioned in the row separation space or the column separation space, and only one of the column control lines and the row control lines may be positioned in an intersection region of the column separation space and the row separation space.

Each of the column control lines may include a column extension line extending in the column direction, and a plurality of column connection lines connecting the column extension line to the upper electrodes in the upper electrode column, and each of the row control lines may include a row extension line extending in the row direction, and a plurality of row connection lines connecting the row extension line to the lower electrodes in the lower electrode row.

Each of the column control lines may include a plurality of column connection lines connecting the upper electrodes adjacent to each other in the column direction, and each of the row control lines may include a plurality of row connection lines connecting the lower electrodes adjacent to each other in the row direction.

The plurality of column connection lines may be arranged in a zigzag pattern with respect to the upper electrodes adjacent to each other in the column direction, the plurality of row connection lines may be arranged in a zigzag pattern with respect to the lower electrodes adjacent to each other in the row direction, and the plurality of column connection lines and the plurality of row connection lines may not overlap each other.

The light emission plate may include an upper substrate, a lower substrate, and a separation wall disposed between the upper substrate and the lower substrate to separate the discharge regions from each other. The discharge regions are filled with at least one discharge gas of Hg, Ne and Xe.

Each of the plurality of upper electrodes may be disposed on a top surface of the light emission plate, each upper electrode column including only one upper electrode extending lengthwise in the column direction of the discharge regions, and each of the plurality of lower electrodes may be disposed on a bottom surface of the light emission plate corresponding to the discharge regions, each lower electrode row including more than one lower electrode arranged in the row direction, and the more than one lower electrode being separated from each other.

An exemplary embodiment provides a display device including a display panel and a light source module. The display panel includes an image display region displaying images according to an image signal, the image display region being divided into a plurality of display regions. The light source module includes a plurality of light source units arranged substantially in a matrix form corresponding to the display regions, respectively, the light source units emitting light having luminance independently varied according to brightness of the corresponding display regions, and a light source control unit supplying a control signal controlling the luminance of the light source units to light source unit columns and light source unit rows. First electrode terminals of the light source units in the light source unit columns are electrically connected to each other, second electrode terminals of the light source units in the light source unit rows are electrically connected to each other, the light source control unit includes a column control unit supplying a corresponding column control signal to the first electrode terminals of each light source unit column, and a row control unit supplying a corresponding row control signal to the second electrode terminals of each light source unit row.

The light source control unit may further include a brightness regulation unit supplying a brightness signal to the column control unit and the row control unit according to the brightness of the corresponding display regions, and the light source unit columns or the light source unit rows successively emit light for one frame according to the brightness signal, the column control signal and the row control signal.

A exemplary embodiment provides a method of driving a display device, the method including generating a brightness control signal based on a brightness of a plurality of display regions of a display panel, supplying the generated brightness control signal to a first direction unit and a second direction unit, the first direction unit successively supplying a first control signal based on the brightness control signal to a plurality of first light source groups, each first light source group extended in a first direction, the second direction unit supplying a second control signal based on the brightness control signal at substantially a same time to a plurality of second light source groups, each second light source group extended in a second direction, the second direction being transverse to the first direction, the first light source groups successively and independently emitting light for one frame based on the brightness signal, the first control signal and the second control signal.

### BRIEF DESCRIPTION OF THE DRAWINGS

The above and other aspects, features and advantages of the present invention will become apparent from the following description of exemplary embodiments given in conjunction with the accompanying drawings, in which:

FIG. 1 is an exploded perspective view illustrating an exemplary embodiment of a display device according to the present invention;

FIG. 2 is a plan view illustrating an exemplary embodiment of a light source module in FIG. 1;

FIG. 3 is a block diagram illustrating an exemplary embodiment of a column control unit of the light source module in FIG. 2;

FIG. 4 is a block diagram illustrating an exemplary embodiment of a row control unit of the light source module in FIG. 2;

FIG. 5 is a view for conceptually illustrating an exemplary embodiment of a driving method of the display device in FIG. 1;

FIG. 6 is an exploded perspective view illustrating another exemplary embodiment of a light source module according to the present invention;

FIG. 7 is a plan view illustrating the light source module in FIG. 6;

FIG. 8 is a cross-sectional view taken along line A-A of FIG. 7;

FIG. 9 is a cross-sectional view taken along line B-B of FIG. 7;

FIG. 10 is an exploded perspective view illustrating another exemplary embodiment of a light source module according to the present invention;

FIG. 11 is a plan view illustrating the light source module in FIG. 10;

FIG. 12 is a cross-sectional view taken along line X-X of FIG. 11;

FIG. 13 is a cross-sectional view taken along line Y-Y of FIG. 11;

FIG. 14 is an exploded perspective view illustrating another exemplary embodiment of a light source module according to the present invention; and

FIG. 15 is a plan view illustrating the light source module in FIG. 14.

### DETAILED DESCRIPTION OF THE INVENTION

Hereinafter, exemplary embodiments of the present invention will be described in detail with reference to the accompanying drawings. However, the present invention is not limited to the embodiments disclosed below but may be implemented into different forms. These embodiments are provided only for illustrative purposes and for full understanding of the scope of the present invention by those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “under,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or “under” relative to other elements or features would then be oriented “above” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

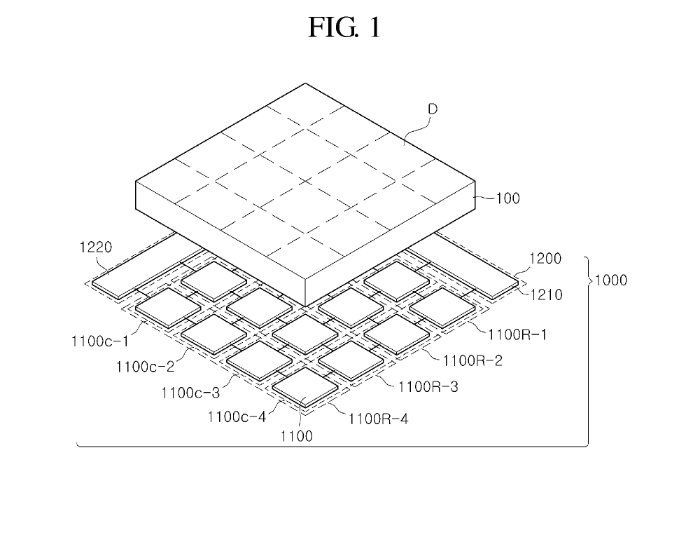

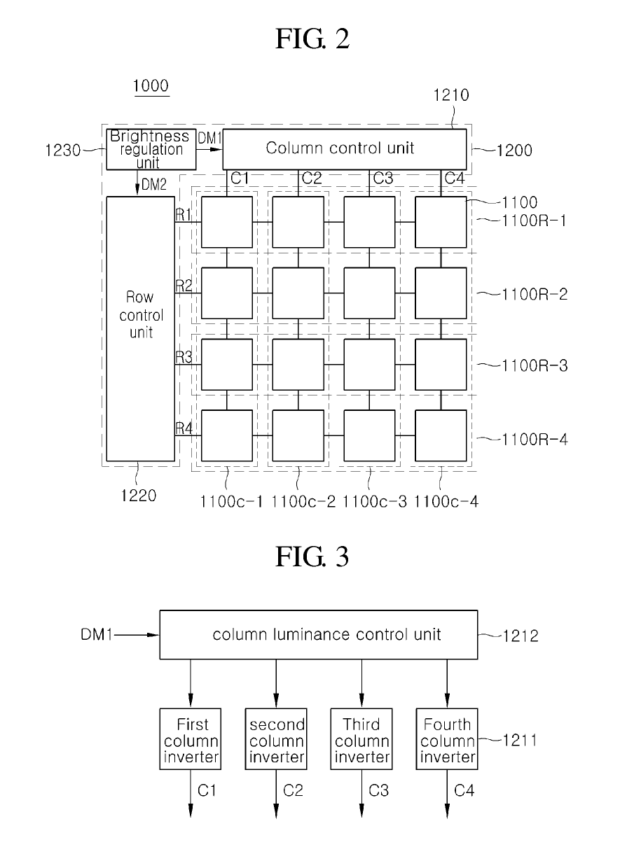

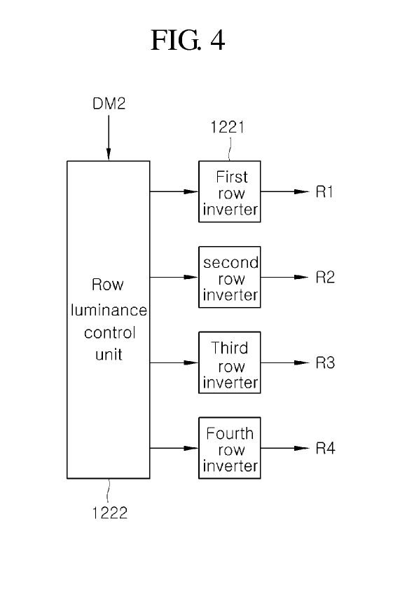

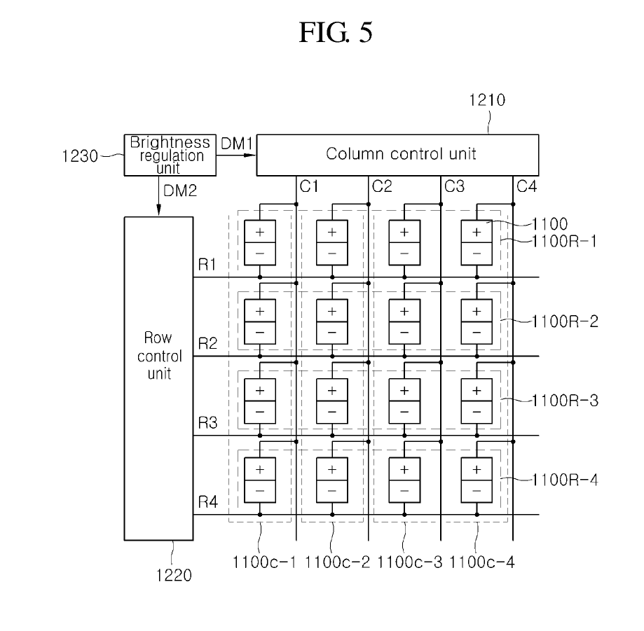

FIG. 1 is an exploded perspective view illustrating an exemplary embodiment of a display device according to the present invention. FIG. 2 is a plan view illustrating an exemplary embodiment of a light source module in FIG. 1. FIG. 3 is a block diagram illustrating an exemplary embodiment of a column control unit of the light source module in FIG. 1, and FIG. 4 is a block diagram illustrating an exemplary embodiment of a row control unit of the light source module in FIG. 1. FIG. 5 is a view for conceptually illustrating an exemplary embodiment of a driving method of the display device in FIG. 1.

Referring to FIGS. 1 to 5, the display device according to the illustrated embodiments includes a display panel 100 and a light source module 1000.

Although not shown, the display panel 100 includes a plurality of gate lines, a plurality of data lines, and a plurality of unit pixels. The plurality of gate lines extend in a first direction, and the plurality of data lines extend in a second direction intersecting the plurality of gate lines. The unit pixels may be provided at intersection regions of the gate and data lines. Although not shown, the unit pixel may include a thin film transistor and a liquid crystal capacitor. The unit pixel may further include a storage capacitor. In exemplary embodiments, the liquid crystal capacitor may include a lower pixel electrode, an upper common electrode, and a liquid crystal interposed between the pixel electrode and the common electrode. In addition, a color filter may be disposed corresponding to, such as on top of, the liquid crystal capacitor. The pixel and common electrodes may be divided into a plurality of domains. The display panel 100 according to the illustrated embodiment is not limited to the above explanation, but may be modified in various forms. In one exemplary embodiment, a plurality of pixels may be disposed in the unit pixel region. Moreover, the unit pixel region may be longer or shorter in an abscissa direction rather than an ordinate direction. Further, the unit pixel region may be modified to have a variety of shapes besides a quadrangular shape.

The display device further includes a gate driving unit for supplying gate turn-on signals to the plurality of gate lines of the display panel 100, respectively, a data driving unit for supplying image signals to the plurality of data lines of the display panel 100, and a signal control unit for controlling the operation of the gate and data driving units. If necessary, the display device may further include a driving voltage generation unit for generating various driving voltages, and an additional operation control unit for generating predetermined clock and control signals. In an exemplary embodiment, the signal control unit, and the data and gate driving units may bee manufactured in the form of an integrated circuit (“IC”) chip and mounted to a printed circuit board (“PCB”). The PCB is electrically connected to the display panel 100 through a flexible printed circuit board (“FPCB”).

The display panel 100 may include upper and lower substrates. In one exemplary embodiment, glass substrates or light transmitting plastic substrates are employed as the substrates. The gate and data driving units may be mounted to the transparent substrate of the display panel 100. In addition, the gate driving unit may be formed in a stage shape on the lower substrate of the display panel 100. That is, when the thin film transistors are formed on the lower substrate, the gate driving unit may be formed together therewith.

As shown in FIGS. 1 and 2, the light source module 1000 includes a plurality of light source units 1100 for supplying light to the display panel 100, and a light source control unit 1200 for controlling the operation of the plurality of light source units 1100.

As shown in FIG. 1, an image display region of the display panel 100 according to the illustrated embodiment is divided into a plurality of display regions D. The plurality of light source units 1100 correspond to the plurality of display regions D, respectively, such that the plurality of the light source units 1100 are disposed overlapping substantially a whole of the image display region, or the plurality of the light source units 1100 are disposed overlapping only the image display region. That is, one of the light source units 1100 is arranged under one of the display regions D corresponding thereto. As used herein, “corresponding” may be used to indicate one element relates to another element substantially in dimension, location, quantity, timing and/or function.

The light source unit 1100 supplies light to the display region D corresponding thereto. The light source unit 1100 supplies the display region D with light having brightness equivalent to an average gradation of an image to be displayed on the corresponding display region D. In one exemplary embodiment, the light source unit 1100 supplies the brightest light if the display region D arranged over the light source unit 1100 displays the brightest gradation (e.g., white), while the light source unit 1100 supplies the darkest light if the display region D arranged thereover displays the darkest gradation (e.g., black). Here, the darkest light means that no light is supplied, e.g., the light source unit 1100 is not driven.

The plurality of display regions D and the plurality of light source units 1100 are arranged substantially in a matrix form. In the illustrated embodiment, the plurality of light source units 1100 arranged in a column direction are defined as light source unit columns 1100C-1, 1100C-2, 1100C-3 and 1100C-4, and the plurality of light source units 1100 arranged in a row direction are defined as light source unit rows 1100R-1, 1100R-2, 1100R-3 and 1100R-4. In the illustrated embodiment, referring to FIGS. 1 and 2, the plurality of light source units 1100 are arranged in a matrix form with the four light source unit columns 1100C-1, 1100C-2, 1100C-3 and 1100C-4, and the four light source unit rows 1100R-1, 1100R-2, 1100R-3 and 1100R-4.

Four light source units 1100 are arranged in each of the light source unit columns 1100C-1, 1100C-2, 1100C-3 and 1100C-4, and each of the light source unit rows 1100R-1, 1100R-2, 1100R-3 and 1100R-4. However, the present invention is not limited thereto. A number of the light source units 1100 arranged in the row direction (e.g., the number of the light source units 1100 in the light source unit rows 1100R-1, 1100R-2, 1100R-3 and 1100R-4), and a number of the light source units 1100 arranged in the column direction (e.g., the number of the light source units 1100 in the light source unit columns 1100C-1, 1100C-2, 1100C-3 and 1100C-4) may be variously changed according to a division method of the image display region of the display panel 100. In exemplary embodiments, the number of the light source units 1100 arranged in the row and/or the column direction may be more or less than four, and may be of a same or a different number between the row and the column directions. In the illustrated embodiment, each of the plurality of light source units 1100 emits light independently of each other of the plurality of the light source units 1100. Therefore, the light source module 1000 may supply light having a different luminance to each of the plurality of display regions D of the display panel 100.

The light source units 1100 disposed in a single column may be referred to as a group of light source units or a column of light source units. Similarly, the light source units 1100 disposed in a single row may be referred to as a group of light source units or a row of light source units. As illustrated in FIGS. 1, 2 and 5, the light source module 1000 includes a plurality of a group of light source units 1100 disposed in both row and column directions, the column direction being transverse to the row direction.

Each of the plurality of light source units 1100 includes a positive terminal (+), a negative terminal (−), and a light source for emitting light by voltage applied to the positive terminal (+) and the negative terminal (−). The light source effectively emits light by a voltage difference between the positive terminal (+) and the negative terminal (−). The light source may be selected from a group consisting of a point light source, a linear light sources and a surface light source. In one exemplary embodiment, the light source may include, but is not limited to, a cold cathode fluorescent lamp (“CCFL”), an external electrode fluorescent lamp (“EEFL”), a light emitting diode (“LED”) and a xenon lamp.

In the illustrated embodiment, as shown in FIG. 5, the positive terminals (+) of the light source units 1100 in each light source unit column 1100C-1, 1100C-2, 1100C-3 or 1100C-4 are electrically connected to each other, and the negative terminals (−) of the light source units 1100 in each light source unit row 1100R-1, 1100R-2, 1100R-3 or 1100R-4 are electrically connected to each other.

The positive terminals (+) of the light source units 1100 in the light source unit columns 1100C-1, 1100C-2, 1100C-3 and 1100C-4 are electrically connected through column control connection lines C1, C2, C3 and C4, respectively. That is, the positive terminals (+) of the light source units 1100 in the first light source unit column 1100C-1 are connected in series through the first column control connection line C1. In exemplary embodiments, the positive terminals (+) of the light source units 1100 in the corresponding light source unit column 1100C-1, 1100C-2, 1100C-3 or 1100C-4 have substantially the same potential (i.e., voltage) by the column control connection line C1, C2, C3 or C4, respectively.

As shown in FIGS. 1 and 2, each of the column control connection lines C1, C2, C3 and C4 may be manufactured in the form of a bridge line for connecting the positive terminals (+) of the light source units 1100 adjacent to each other in the column direction. However, the present invention is not limited thereto. Alternatively, as shown in FIG. 5, each of the column control connection lines C1, C2, C3 and C4 may be manufactured in the form of a single line.

In addition, the negative terminals (−) of the light source units 1100 in the light source unit rows 1100R-1, 1100R-2, 1100R-3 and 1100R-4 are electrically connected through row control connection lines R1, R2, R3 and R4, respectively. That is, the negative terminals (−) of the light source units 1100 in the first light source unit row 1100R-1 are connected in series through the first row control connection line R1. In exemplary embodiments, the negative terminals (−) of the light source units 1100 in the corresponding light source unit row 1100R-1, 1100R-2, 1100R-3 or 1100R-4 have substantially the same potential (i.e., voltage) by the row control connection line R1, R2, R3 or R4.

As shown in FIGS. 1 and 2, each of the row control connection lines R1, R2, R3 and R4 may be manufactured in the form of a bridge line for connecting the negative terminals (−) of the light source units 1100 adjacent to each other in the row direction. However, the present invention is not limited thereto. Alternatively, as shown in FIG. 5, each of the row control connection lines R1, R2, R3 and R4 may be manufactured in the form of a single line.

The column control connection lines C1, C2, C3 and C4 and the row control connection lines R1, R2, R3 and R4 are connected to the light source control unit 1200, and supply column and row control signals to the corresponding light source unit columns 1100C-1, 1100C-2, 1100C-3 and 1100C-4 and the corresponding light source unit rows 1100R-1, 1100R-2, 1100R-3 and 1100R-4, respectively.

Referring to FIGS. 1, 2 and 5, the light source control unit 1200 includes a column control unit 1210, a row control unit 1220 and a brightness regulation unit 1230.

The brightness regulation unit 1230 calculates the brightness of each of the display regions D of the display panel 100 by using the image signals supplied to the respective display regions D, and then outputs a plurality of first and second brightness signals DM1 and DM2 corresponding to the calculated brightness of the display regions D.

The column control unit 1210 supplies column control signals to the respective light source unit columns 1100C-1, 1100C-2, 1100C-3 and 1100C-4 according to the first brightness signals DM1. As shown in FIG. 3, the column control unit 1210 includes a plurality of column inverters 1211 connected to the plurality of column control connection lines C1, C2, C3 and C4 to supply a plurality of column control signals, and a column luminance control unit 1212 for modulating the plurality of column control signals supplied by the plurality of column inverters 1211 according to the first brightness signals DM1. In exemplary embodiments, the column luminance control unit 1212 modulates pulse widths or voltage levels (i.e., amplitudes) of the column control signals. This means that pulse width modulation signals and/or amplitude modulation signals can be used as the column control signals.

The row control unit 1220 supplies row control signals to the respective light source unit rows 1100R-1, 1100R-2, 1100R-3 and 1100R-4 according to the second brightness signals DM2. The row control signals include first level row control signals and second level row control signals. As shown in FIG. 4, the row control unit 1220 includes a plurality of row inverters 1221 connected to the plurality of row control connection lines R1, R2, R3 and R4 to supply the first or second level row control signals to the plurality of row control connection lines R1, R2, R3 and R4, and a row luminance control unit 1222 for controlling output of the row inverters 1221 to successively supply the first level row control signals to the plurality of row control connection lines R1, R2, R3 and R4. In an exemplary embodiment, the first level row control signals are supplied to an entire of the plurality of row control connection lines R1, R2, R3 and R4 for one (e.g., single) frame. The first level row control signals are supplied to the respective row control connection lines R1, R2, R3 and R4 for the substantially same time. As four row control connection lines are provided in the illustrated embodiment, the first level row control signal is supplied to each of the plurality of row control connection lines for ¼ frame time.

In the illustrated embodiment, a voltage level of the first level row control signal and a voltage level of the column control signal preferably have a voltage difference (e.g., a light emitting voltage difference) at which the light source unit 1100 emits light. In addition, a voltage level of the second level row control signal and a voltage level of the column control signal preferably have a voltage difference (e.g., a non light emitting voltage difference) at which the light source unit 1100 does not emit light.

The first level row control signal and the column control signal can have different voltage levels, and the second level row control signal and the column control signal can have the same voltage level. In one exemplary embodiment, the light source unit 1100 emits light when the voltage difference between the positive terminal and the negative terminal is over +10 V. If a voltage of 10 V is used as the column control signal, a voltage below 0 V or over 20 V may be used as the first level row control signal. In addition, a voltage of 1 to 19 V may be used as the second level row control signal.

An exemplary embodiment of the operation of the light source module according to the illustrated embodiment will be explained.

In the light source module 1000 according to the illustrated embodiment, the light source units 1100 in the plurality of light source unit rows 1100R-1, 1100R-2, 1100R-3 and 1100R-4 successively emit light for the same time during one frame. In addition, the plurality of light source units 1100 independently emit light to the respective display regions D of the display panel 100 corresponding to the light source units 1100.

The row control unit 1220 successively applies the first level row control signals to a portion of the plurality of row control connection lines R1, R2, R3 and R4 according to the second brightness signals DM2 supplied by the brightness regulation unit 1230. The portion of the plurality of row control connection lines R1, R2, R3 and R4 may be a single one of the plurality of row control connection lines R1, R2, R3 and R4. The second level row control signals are supplied to a remaining portion of the row control connection lines R1, R2, R3 and R4 that are not applied with the first level row control signal.

Then, the column control unit 1210 supplies corresponding column control signals to respective column control connection lines C1, C2, C3 and C4 according to the first brightness signals DM1 of the brightness regulation unit 1230. Advantageously, the corresponding column control signals are supplied to the positive terminals (+) of the light source units 1100, and the first level row control signals are supplied to the negative terminals (−) thereof, so that the light source units 1100 emit light.

Emission of light from the light source units 1100 will be explained in more detail below with reference to FIG. 5. The light emission of the light source units 1100 in the first light source unit row 1100R-1 will be described.

The first row inverter 1221 applies a first level row control signal only to the first row control connection line R1 for ¼ frame as directed by the row luminance control unit 1222 of the row control unit 1220. As illustrated in FIG. 5, the first row control connection line R1 is connected to the negative terminals (−) of the plurality of light source units 1100 in the first light source unit row 1100R-1 (e.g., in a first light source (row) group). Accordingly, the first level row control signal is supplied to the negative terminals (−) of the plurality of light source units 1100 in the first light source unit row 1100R-1 only. The other second to fourth row inverters 1221 supply second level row control signals to the remaining second to fourth row control connection lines R2, R3 and R4 that are not supplied with the first level row control signal.

The first to fourth column inverters 1211 respectively supply corresponding column control signals to the first to fourth column control connection lines C1, C2, C3 and C4 as directed by the column luminance control unit 1212 of the column control unit 1210. The corresponding column control signals correspond to the calculated brightness of the display regions D positioned in the first row, corresponding to the light source units 1100 in the first light source unit row 1100R-1, among the plurality of display regions D of the display panel 100. As illustrated in FIG. 5, the first to fourth column control connection lines C1, C2, C3 and C4 are connected to the positive terminals (+) of the plurality of light source units 1100 in the first to fourth light source unit columns 1100C-1, 1100C-2, 1100C-3 and 1100C-4, respectively. Each of the first to fourth light source unit columns 1100C-1, 1100C-2, 1100C-3 and 1100C-4 include first to fourth light source (column) groups. Therefore, the column control signals are applied to the positive terminals (+) of the plurality of light source units 1100 in the first to fourth light source unit columns 1100C-1, 1100C-2, 1100C-3 and 1100C-4. That is, the corresponding column control signals are supplied at substantially the same time to the positive terminals (+) of a whole of the plurality of the light source units 1100 in the light source module 1000, respectively.

The first level row control signal has a voltage difference from the column control signal to the extent that the light source units 1100 may emit light when the first level row control signal is applied to respective light source units 1100 of a specific row. In the illustrated embodiment, the first level row control signal is applied to the negative terminals (−) of the first light source unit row 1100R-1 through the first row control connection line R1 of the row control unit 1220, so that only the light source units 1100 in the first light source unit row 1100R-1 emit light. That is, each of the light source units 1100 in the first light source unit row 1100R-1 emits light having the corresponding luminance according to the corresponding column control signal applied to the positive terminal (+). In exemplary embodiments, the column control signal is a pulse width modulation signal, and the width thereof is preferably varied according to target luminance of each light source unit 1100 as corresponding to a respective image display region D.

The second level row control signals have a voltage difference from the column control signals to the extent that the light source units 1100 do not emit light. The second level row control signals are applied to the negative terminals (−) of the second to fourth light source unit rows 1100R-2, 1100R-3 and 1100R-4, except the first light source unit row 1100R-1. Accordingly, the light source units 1100 in the second to fourth light source unit rows 1100R-2, 1100R-3 and 1100R-4 do not emit light, while column control signals are supplied at substantially the same time to the positive terminals (+) of the light source units 1100 in the second to fourth light source unit rows 1100R-2, 1100R-3 and 1100R-4.

According to the exemplary embodiment of operation of the display device, the light source units 1100 in the first to fourth light source unit rows 1100R-1, 1100R-2, 1100R-3 and 1100R-4 are driven successively on a row basis for one frame. That is, each of the light source units 1100 in a specific row emits light having the corresponding luminance according to the corresponding column control signal applied to the positive terminals (+) of an entire of the light source units 1100 in the specific row, while the remaining light source units 1100 in all of the other rows of the light source module 1000 do not emit light. Each of the light source units 1100 within each the light source unit rows 1100R-1, 1100R-2, 1100R-3 and 1100R-4 may be individually driven to correspond to a brightness of the display regions D, respectively. A one frame is relatively a very short time (i.e., 1/60 second or 1/120 second).

Therefore, even if the light source units 1100 in the first to fourth light source unit rows 1100R-1, 1100R-2, 1100R-3 and 1100R-4 are successively driven for one frame, a user essentially cannot recognize it.

As in the illustrated embodiment, all of the light source units 1100 do not emit light at substantially the same time for one frame, but the light source units 1100 in the light source unit rows 1100R-1, 1100R-2, 1100R-3 and 1100R-4 emit light on a row basis. Advantageously, the brightness of the respective light source units 1100 in the light source unit rows 1100R-1, 1100R-2, 1100R-3 and 1100R-4 is controlled according to desired the images of the display panel 100, whereby the power consumption of the light source module 1000 can be reduced.

Further, in the illustrated embodiment, the sixteen light source units of the light source module 1000 may independently emit light by means of eight inverters, four of the column control unit 1200 and four of the row control unit 1220. In conventional display devices, sixteen inverters are necessary to enable sixteen light source units to independently emit light, and a wiring process of connecting the light source units to the inverters is complicated. However, according to the arrangement and light emission method of the illustrated embodiment, a number of connection lines between the light source units and the inverters can be reduced, and a process of connecting the light source units to the inverters is simplified, as sixteen light source units independently emit light only by means of eight inverters. Advantageously, a manufacturing process of the light source module 1000 can be simplified, and a manufacturing cost can be reduced.

It has been described above that the light source units 1100 of the light source unit rows 1100R-1, 1100R-2, 1100R-3 and 1100R-4 are driven successively on a row basis for one frame. However, the present invention is not limited thereto. Alternatively, the light source units 1100 may be driven successively on a column basis for one frame. In one exemplary embodiment, the row control unit 1220 and the column control unit 1210 may perform opposite operations to each other. That is, the row control unit 1220 may supply pulse width-modulated or amplitude-modulated row control signals to the plurality of row control connection lines R1, R2, R3 and R4, and the column control unit 1210 may successively supply first level column control signals to the plurality of column control connection lines C1, C2, C3 and C4. In addition, the row control unit 1220 according to the illustrated embodiment may perform the same operation as the column control unit 1210 explained with reference to FIGS. 2 and 3. That is, the plurality of row inverters 1221 of the row control unit 1220 may be connected to the plurality of row control connection lines R1, R2, R3 and R4, and supply a plurality of row control signals. The row luminance control unit 1222 may modulate the plurality of row control signals supplied to the plurality of row inverters 1221 according to the second brightness signals DM2.

In the illustrated embodiment, as the light source units 1100, a variety of light emitting sources and/or groups thereof may be used. In alternative embodiments of the present invention, as the light source unit, a surface light source lamp may be used. Another exemplary embodiment of a light source module according to the present invention will be described below. Same descriptions as the illustrated embodiment in FIGS. 2-4 above will be omitted. The features explained below may be applied to the display device of FIGS. 1-5.

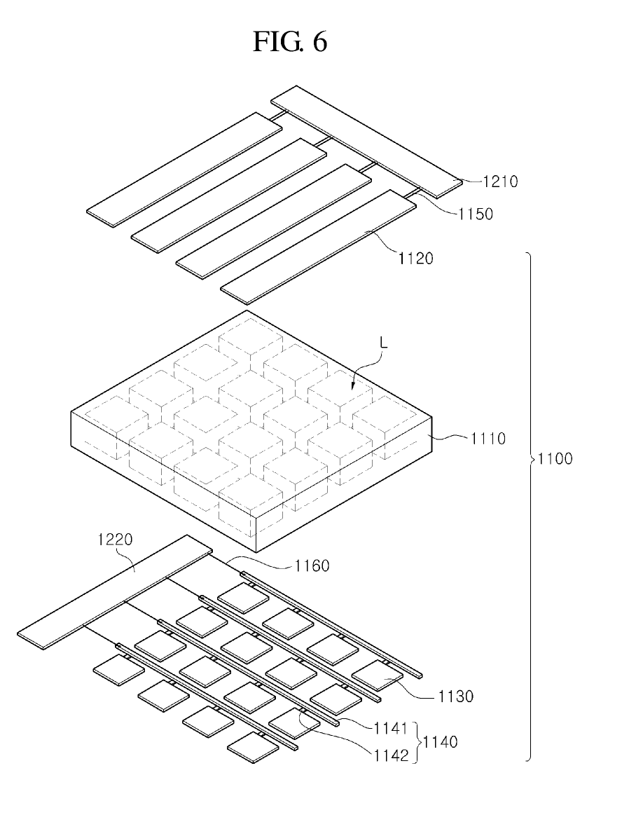

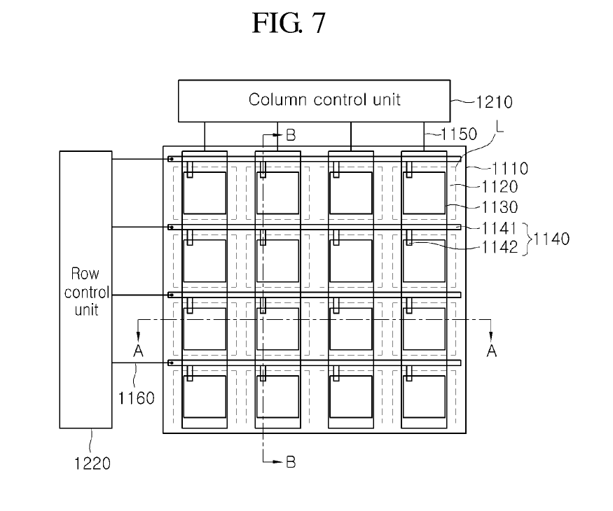

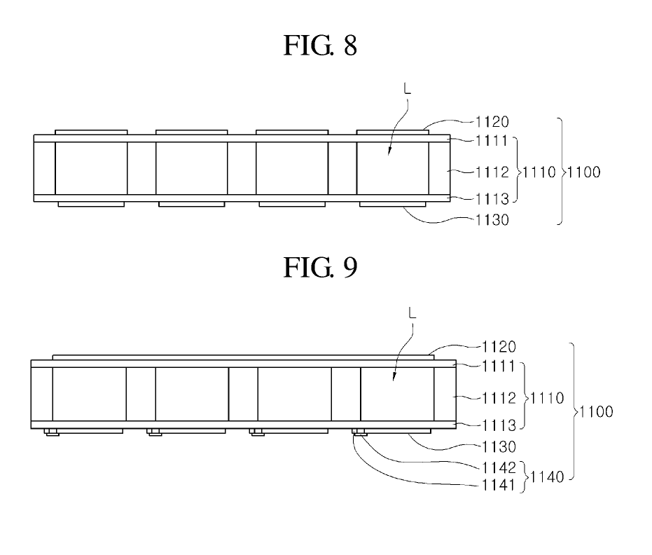

FIG. 6 is an exploded perspective view illustrating another exemplary embodiment of a light source module according to the present invention. FIG. 7 is a plan view illustrating the light source module in FIG. 6, FIG. 8 is a cross-sectional view taken along line A-A of FIG. 7, and FIG. 9 is a cross-sectional view taken along line B-B of FIG. 7.

Referring to FIGS. 6 to 9, a light source module 1000 according to the illustrated embodiment includes a light source unit 1100, a column control unit 1210 and a row control unit 1220.

The light source unit 1100 includes a light emission plate 1110 in which a plurality of discharge regions L are arranged substantially in a matrix form and are separated from each other, a plurality of upper electrodes 1120 formed over the light emission plate 1110 to extend in respective column directions of the matrix-arranged discharge regions L and to be arranged in a transverse row direction of the matrix-arranged discharge regions L, a plurality of lower electrodes 1130 formed under the light emission plate 1110 (e.g., opposite to the plurality of upper electrodes 1120 relative to the light emission plate 1110) to be positioned in and corresponding to the respective discharge regions L, and a plurality of row control lines 1140 for connecting the lower electrodes 1130 arranged in the respective row directions of the matrix-arranged discharge regions L to each other.

FIG. 7 illustrates first to fourth light source groups, and each of the first to fourth light source groups is disposed in a row direction, e.g., left to right in the plan view of FIG. 7. Fifth to eighth light source groups are illustrated as each being disposed in column direction, e.g., up and down in the plan view of FIG. 7. Each of the upper electrode 1120 corresponding to a specific column of discharge regions L may completely overlap all of the lower electrodes 1130 corresponding to that specific column as illustrated in FIG. 7.

As shown in FIGS. 8 and 9, the light emission plate 1110 includes an upper substrate 1111, a lower substrate 1113, and separation walls 1112 disposed between the upper substrate 1111 and the lower substrate 1113 to separate the discharge regions L from each other. Each discharge region L is hermetically sealed up by the upper substrate 1111, the lower substrate 1113 and the separation walls 1112.

In exemplary embodiments, transparent substrates are used as the upper substrate 1111 and the lower substrate 1113. Advantageously, light generated in the discharge regions L can be emitted to the outside of the light source unit through the upper substrate 1111 and/or the lower substrate 1113. Alternatively, an opaque substrate may be used as the lower substrate 1113. As in the illustrated embodiment, the upper substrate 1111 and the lower substrate 1113 may be manufactured in the shape of a quadrangular plate. However, the present invention is not limited thereto. The shapes of the upper substrate 1111 and the lower substrate 1113 may be variously changed according to a shape of a display panel.

The separation walls 1112 include column separation walls extending in the column directions and row separation walls extending in the row directions. Quadrangular areas, or through holes, are defined by the column separation walls and the row separation walls. These through holes correspond to the discharge regions L, respectively. The shape of the through hole is not limited to a quadrangle but may be a circle, ellipse or polygon. In one exemplary embodiment, the separation walls 1112 may be manufactured in the shape of a plate with through holes.

In one exemplary embodiment, the upper substrate 1111 and the lower substrate 1113 are bonded to upper and lower portions of the separation walls 1112, whereby the light emission plate 1110 is manufactured. The areas, or spaces, within the quadrangular through holes of the separation walls 1112 (e.g., the discharge regions L) are preferably filled with a discharge gas. Here, Hg gas, Ne gas and Xe gas may be used as the discharge gas. In the illustrated embodiment, the discharge regions L are filled with a discharge gas containing Xe gas. In addition, although not shown, a phosphor may be formed on the surfaces of the upper substrate 1111 and/or the lower substrate 1113 bonded to the separation walls 1112. Moreover, a phosphor may be formed on sidewall surfaces of the quadrangular through holes. The separation walls 1112 serve to reduce or effectively prevent discharge interference between the adjacent discharge regions L. Advantageously, each discharge region L can independently emit light.

As shown in FIG. 6, each of the upper electrodes 1120 is manufactured in the shape of a planar bar extending in the column direction of the discharge regions L. In the illustrated embodiment, sixteen discharge regions L of the light emission plate 1110 are arranged in a 4×4 matrix form. The four upper electrodes 1120 are disposed on a top or upper surface of the light emission plate 1110.

The upper electrodes 1120 may include a transparent conductive film. The transparent conductive film may be formed of a material selected from the group consisting of indium tin oxide (ITO), indium zinc oxide (IZO) and ZnO. In the illustrated embodiment, the upper electrodes 1120 may be manufactured by depositing the transparent conductive film on the top surface of the light emission plate 1110, e.g., an upper surface of the upper substrate 1111, and then etching a portion of the transparent conductive film.

The respective upper electrodes 1120 may be directly connected to the column control unit 1210 through first conductive lines 1150. A single first conductive line 1150 may be connected to a single upper electrode 1120 as illustrated in FIG. 6, such as in a one-to-one relationship. The column control unit 1210 is connected to a plurality of the first conductive line 1150. A portion of each of the first conductive line 1150 may overlap both the light emission plate 1110 and the column control unit 1210 in a plan view, and a remaining portion of the each of the first conductive line 1150 is extended between the light emission plate 1110 and the column control unit 1210, as illustrated in FIG. 7.

In an exemplary embodiment, a connection pad (not shown) may be connected with the first conductive line 1150 and be disposed at one respective end of each upper electrode 1120. Portions of the upper electrodes 1120 may extend to sidewall surfaces of the upper substrate 1111, such that the upper electrodes 1120 overlap an entire of the upper substrate 1111 between opposing edges of the upper substrate in a plan view.

As shown in FIG. 6, each of the lower electrodes 1130 is manufactured in a relatively small and discrete island-shaped plate substantially corresponding to the discharge region L, such as in a one-to-one relationship with the discharge regions L. As in the illustrated embodiment, sixteen lower electrodes 1130 are provided in correspondence with sixteen discharge regions L. The lower electrodes 1130 may include a transparent conductive film or a metal thin film. In the illustrated embodiment, light generated in the discharge regions L is emitted to the outside of the light source unit 1100 through the upper electrodes 1120. Metal thin films having a light reflection property may be effectively used as the lower electrodes 1130.

A dimension of each of the lower electrodes 1130 may be smaller than or equal to a dimension of an individual discharge region L in plane size. In one exemplary embodiment, if a plane size of a discharge region L is 100%, a size of the lower electrode 1130 is preferably 80 to 100%. Where the size of the lower electrodes 1130 is over the above range, or greater than the dimension of the discharge region L, a discharge interference occurs between adjacent discharge regions L. In addition, when a space for the row control lines 1140 to be formed is minimized or reduced, it is difficult to secure a sufficient process margin for manufacturing the row control lines 1140. Conversely, where the size of the lower electrodes 1130 is below the above range, the lower electrode 1130 cannot sufficiently cover the surface of the discharge region L, such that a sufficient discharge does not occur in the discharge region L.

In alternative embodiments, the lower electrode 1130 may be manufactured in the shape of a bar extending in the column direction of the discharge regions L like the upper electrodes 1120 explained above. However, when a lower electrode 1130 is shaped similar to an upper electrode 1120, such as in the bar shape, a discharge interference may occur between the adjacent discharge regions L. Since the bar-shaped lower electrodes 1130 would extend to pass through the separation walls 1112, the discharge interference may be generated on the boundaries of the discharge regions L (both side regions of the separation walls 1112 through which the lower electrodes 1130 pass). To reduce or effectively prevent discharge interference when the lower electrodes 1130 are bar-shaped, a width of the separation walls 1112 may be increased to overlap with the lower electrodes 1130. However, if the width of the separation walls 1112 is excessively large, the regions of the separation walls 1112 are recognized as dark lines in the light source module 1000. Accordingly, the lower electrodes 1130 may be manufactured in not a bar shape but an island shape as illustrated in FIGS. 6-9, corresponding to the discharge region L, thereby reducing the discharge interference.

The row control lines 1140 include extension lines 1141 extending in the row directions of the discharge regions L and substantially parallel to an arrangement direction of the lower electrodes 1130 in the row directions, and connection lines 1142 for directly connecting each of the extension lines 1141 to the lower electrodes 1130 arranged in the row directions. A single connection line 1142 may be connected to a single lower electrode 1130 as illustrated in FIG. 6, such as in a one-to-one relationship. A single extension line 1141 may connected to a plurality of the connection line 1142. A single extension line 114 may be connected to each of the lower electrodes 1130 in a given row of the plurality of lower electrodes 1130 through the plurality of the connection line 1142.

The extension lines 1141 are disposed in regions of discharge blocks (e.g., the separation walls 1122) between the discharge regions L, and may not overlap the lower electrodes 1130 as illustrated in FIG. 7. The extension lines 1141 may extend to pass through the discharge regions L in the row directions of the discharge regions L. However, in order to generate sufficient discharge in the discharge regions L, it is effective to form the extension lines 1141 in only the regions of the separation walls 1112, these regions excluding the lower electrodes 1130 and/or the discharge regions L. The extension lines 1141 may be directly connected to the row control unit 1220 through second conductive lines 1160, respectively.

A single second conductive line 1160 may be connected to a single upper electrode 1120 as illustrated in FIG. 6, such as in a one-to-one relationship. The column control unit 1210 is connected to a plurality of the first conductive line 1150. A portion of each of the second conductive line 1160 may overlap both the light emission plate 1110 and the row control unit 1220 in a plan view, and a remaining portion of the each of the second conductive line 1160 is extended between the light emission plate 1110 and the row control unit 1220, as illustrated in FIG. 7.

The light source unit 1100 according to the illustrated embodiment of FIGS. 6-9 is a surface light source lamp emitting light by a difference of voltages applied to upper and lower portions of the respective discharge regions L. In exemplary embodiments, the voltage difference may preferably range from 500 to 2000 V. In the illustrated embodiment, the upper electrodes 1120 are positioned in the upper portion of the discharge regions L, and the lower electrodes 1130 are positioned in the lower portion of the discharge regions L.

Each of the upper electrodes 1120 is supplied with a first voltage from the column control unit 1210. The column control unit 1210 may be disposed entirely at a first (e.g., top) side of the light emission plate 1110 in the plan view of FIG. 7, but the invention is not limited thereto. The plurality of discharge regions L arranged in the column directions are supplied with the first voltages from the column control unit 1210 directly through the upper electrodes 1120. Each of the lower electrodes 1130 is supplied with a second voltage through the row control line 1140 connected to the row control unit 1220. The row control unit 1220 may be entirely disposed at a second (e.g., left) side of the light emission plate 1110 in the plan view of FIG. 7, the second side being adjacent to the first side of the light emission plate 1110, but the invention is not limited thereto. The plurality of discharge regions L arranged in the row directions are directly supplied with the second voltages by the row control lines 1140 and the lower electrodes 1130. The plurality of the upper electrode 1120, the plurality of the lower electrode 1130 and the plurality of the discharge region L may occupy (e.g., overlap) substantially an entire of an image display region of the display device as illustrated in FIG. 7.

The light source unit 1100 according to the illustrated embodiment emits light as in the embodiment of FIGS. 1-5. Therefore, the descriptions on the operation of the light source unit of FIGS. 6-9 will be omitted.

The shape of the light source module according to the embodiment of FIGS. 6-9 is not limited to that described and illustrated above, but may be modified variously.

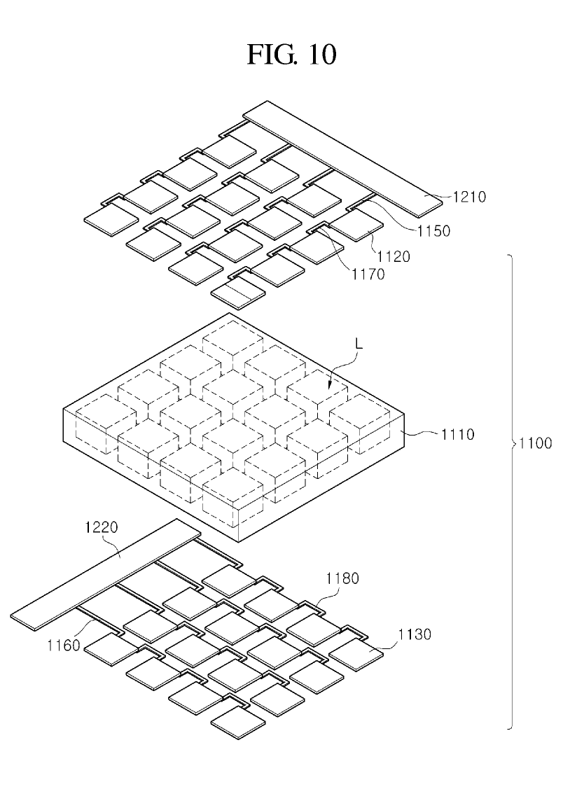

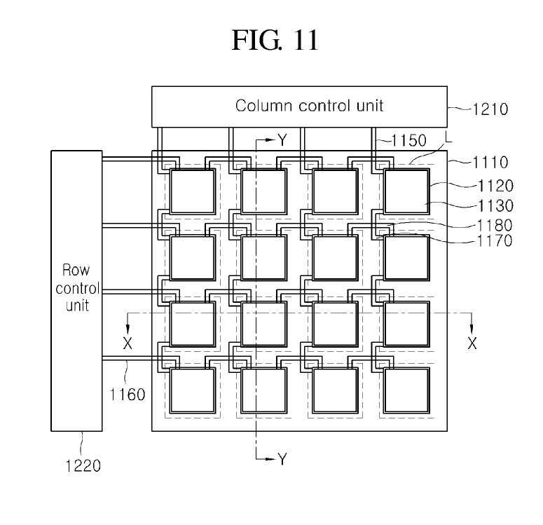

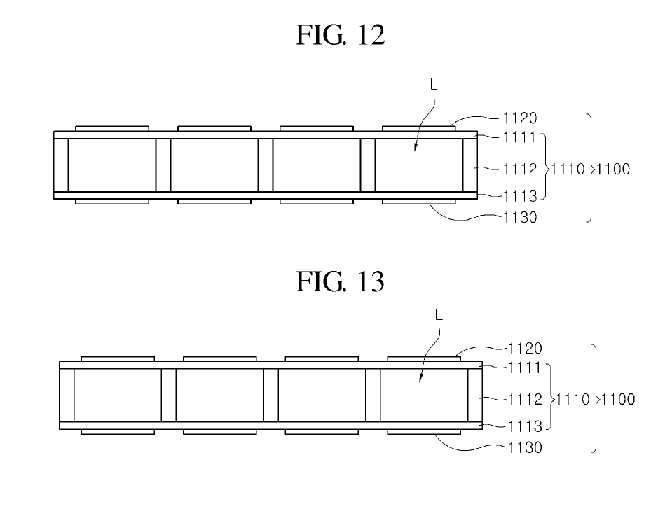

FIG. 10 is an exploded perspective view illustrating another exemplary embodiment a light source module according to a modification of the embodiment in FIGS. 6-9, FIG. 11 is a plan view illustrating the light source module in FIG. 10, FIG. 12 is a cross-sectional view taken along line X-X of FIG. 11, and FIG. 13 is a cross-sectional view taken along line Y-Y of FIG. 11.

A light source unit 1100 of a light source module 1000 according to the illustrated embodiment includes a light emission plate 1110 in which a plurality of a discharge region L is arranged substantially in a matrix form and separated from each other, a plurality of an upper electrode 1120 respectively disposed on upper side of the discharge regions L, a plurality of a column connection line 1170 directly connecting the upper electrodes 1120 placed in each respective column of the matrix-arranged discharge regions L, a plurality of a lower electrode 1130 respectively disposed on lower sides of the discharge regions L, and a plurality of a row connection line 1180 directly connecting the lower electrodes 1130 placed in each respective row of the matrix-arranged discharge regions L.

As shown in FIGS. 10 and 11, each of the plurality of upper electrodes 1120 according to the illustrated embodiment is manufactured in the shape of a continuous and indivisible island, each of the upper electrodes 1120 corresponding to a discharge region L. The upper electrodes 1120 are disposed on a top surface of the light emission plate 1110 (i.e., on an upper substrate 1111), and the lower electrodes 1130 are formed on a bottom surface of the light emission plate 1110 (i.e., on a lower substrate 1113). If a plane size of an individual discharge region L is 100%, each size of an individual upper electrode 1120 and a lower electrode 1130 is effectively 80 to 100%.

Each of the upper electrode 1120 corresponding disposed overlapping a corresponding lower electrode 1130 may completely overlap a whole of the corresponding lower electrode 1130, in both the row and column direction, as illustrated in FIGS. 11-13. Referring to the plan view of FIGS. 12 and 13, each of the upper and lower electrodes 1120 and 1130 may be disposed in areas corresponding only to the discharge regions L, where these areas exclude the separation walls 1112.

As illustrated in FIGS. 10 and 11, the column connection lines 1170 are provided to connect each of the plurality of the upper electrode 1120 disposed in a column in series. Moreover, the row connection lines 1180 are provided to connect each of the plurality of the lower electrode 1130 disposed in a row in series. Both the column connection lines 1170 and the row connection lines 1180 may be disposed mostly in between the discharge regions L shown in broken lines in FIGS. 10 and 11. As best observed in FIG. 11, respective longitudinal portions of both the column connection lines 1170 and the row connection lines 1180 are disposed completely in areas overlapping only the separation walls 1112 (e.g., between the discharge regions L). Respective transverse portions of both the column connection lines 1170 and the row connection lines 1180 are disposed partly in the area overlapping the separation walls 1112, where a remaining part of the transverse portions connected to an upper or lower electrode 1120 and 1130 overlaps the discharge regions L.

The column connection lines 1170 and the row connection lines 1180 include a plurality of bridge lines, such as illustrated in FIGS. 1 and 2. The bridge lines connect the two adjacent upper electrodes 1120 or the two adjacent lower electrodes 1130, respectively. The upper electrodes 1120 and the lower electrodes 1130, which are considered “island-shaped” electrodes, are positioned at the upper and lower portions of the discharge regions L, respectively. As illustrated in FIGS. 10 and 11, the upper electrodes 1120 and the lower electrodes 1130 are both arranged in a matrix form.

A first column of the matrix-arranged upper electrodes 1120 will be explained. As shown in FIGS. 10 and 11, four of the upper electrodes 1120 are placed in the first column. The four upper electrodes 1120 in the first column are connected through three of the bridge-shaped column connection lines 1170. In the illustrated embodiment, the column connection lines 1170 are positioned in a left region of the column (e.g., towards the row control unit 1120). In addition, a first row of the matrix-arranged lower electrodes 1130 will be explained. Four of the lower electrodes 1130 are placed in the first row. The four lower electrodes 1130 in the first row are connected by three of the bridge-shaped row connection lines 1180, and are positioned in a region of the row located towards the column control unit 1210.

Further, the upper electrodes 1120 connected in series through the column connection lines 1170 are connected to a column control unit 1210 through first conductive lines 1150. That is, the upper electrode 1120 placed in one end of each upper electrode column is connected to the first conductive line 1150, and the first conductive line 1150 is connected to an output terminal of the column control unit 1210. Here, the upper electrode column means upper electrodes arranged in a single column extending in the column direction. Accordingly, the column control unit 1210 supplies first voltages to the upper electrode columns, and within each column the upper electrodes are connected in series through the first conductive lines 1150. Since the upper electrodes in the upper electrode columns are connected in series, the first voltages are supplied to the whole upper electrodes 1120 in the upper electrode columns, respectively.

A single column connection line 1170 connects a pair of adjacent upper electrodes 1120 arranged in the column. A plurality of the upper electrode 1120 aligned (e.g. substantially linearly) in a single column is connected to the column control unit 1210 by a single first conductive line 1150. One first conductive line 1150 may be provided for each column of the upper electrodes 1120, but the invention is not limited thereto.

In addition, the lower electrodes 1130 connected in series through the row connection lines 1180 are connected to a row control unit 1220 through second conductive lines 1160. That is, the lower electrode 1130 placed in one end of each lower electrode row is connected to the second conductive line 1160, and the second conductive line 1160 is connected to the row control unit 1220. Here, the lower electrode row means lower electrodes arranged in a single row extended in the row direction. The second conductive lines 1160 supply second voltages of the row control unit 1220 to the lower electrode rows. Since the lower electrodes in the lower electrode rows are connected in series, the second voltages are supplied to the whole lower electrodes 1130 in the lower electrode rows, respectively.

A single row connection line 1180 connects a pair of adjacent lower electrodes 1130 arranged in the row. A plurality of the lower electrode 1130 aligned (e.g. substantially linearly) in a single row is connected to the row control unit 1220 by a single second conductive line 1160. One second conductive line 1160 may be provided for each row of the lower electrodes 1130, but the invention is not limited thereto. Multiple row connection lines 1180 between adjacent lower electrodes 1130 are illustrated in FIGS. 10 and 11 to connect a row of the lower electrodes 1130, where in contrast, only one of the extension line 1141 is used in FIGS. 6-9 to connect a row of the lower electrodes 1130.

As described above, the plurality of upper electrodes 1120 placed in the column directions are supplied with the first voltages through the column connection lines 1170 and the first conductive lines 1150. Although it has been described that the column connection lines 1170 and the first conductive lines 1150 are independently formed as separate elements, the present invention is not limited thereto. Alternatively, the column connection lines 1170 and the first conductive lines 1150 may be formed as a continuous and indivisible unit. That is, the first conductive lines 1150 may be elements included in the column connection lines 1170. The plurality of lower electrodes 1130 placed in the row directions are supplied with the second voltages through the row connection lines 1180 and the second conductive lines 1160. Similarly, the second conductive lines 1160 may also be elements included in the row connection lines 1180, such that the row connection lines 1180 and the second conductive lines 1160 are also formed as a continuous and indivisible unit.

According to the embodiment of FIGS. 10-13, since the upper electrodes 1120 are formed in an island shape, and separated from each other to correspond to the discharge regions L, it is possible to advantageously reduce the discharge interference caused by the upper electrodes 1120 extending to upper portions of separation walls 1112 of the light emission plate 1110 illustrated in FIGS. 6-9. As a further advantage, since the upper electrodes 1120 or the lower electrodes 1130 adjacent to each other in the respective column direction or the row direction are connected by multiples of the column connection lines 1170 or the row connection lines 1180, it is possible to further reduce or effectively prevent the discharge interference caused by the connection lines.

In addition, the arrangements of the column connection lines 1170 and the row connection lines 1180 may be modified variously.

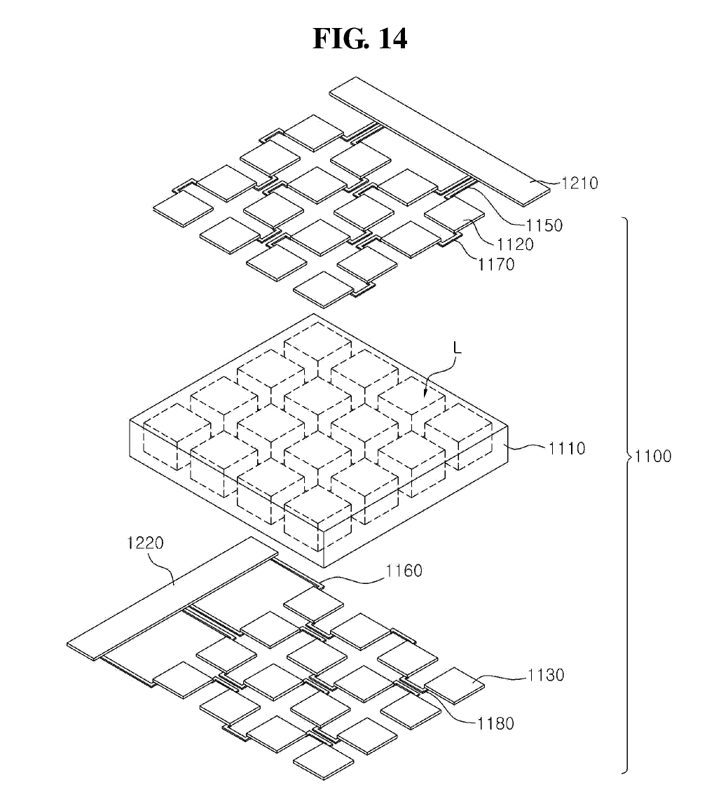

FIG. 14 is an exploded perspective view illustrating another exemplary embodiment of a light source module according to another modification of the embodiment in FIGS. 6-9, and FIG. 15 is a plan view illustrating the light source module in FIG. 14.

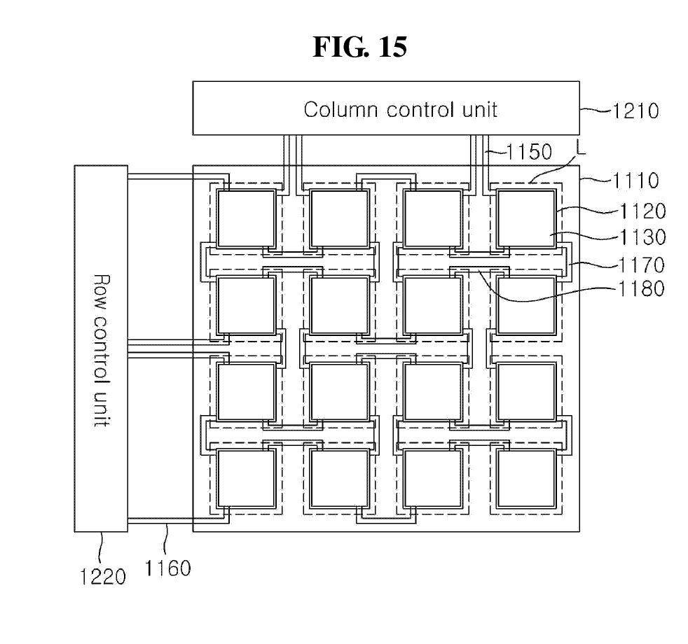

As shown in FIGS. 14 and 15, in each column or row, column connection lines 1170 and row connection lines 1180 are respectively arranged in a zigzag pattern in a plan view. Only one of the column connection lines 1170 or the row connection lines 1180 are positioned at an intersection region of separation walls 1112, such that the column connection lines 1170 and the row connection lines 1180 do not overlap each other, unlike in FIG. 11.

As shown in FIGS. 14 and 15, four upper electrodes 1120 in a first column are connected in series through three column connection lines 1170. The first column connection line 1170 may be positioned on the left side (e.g., towards the row control unit 1220) of the first column, the second column connection line 1170 is positioned on the right side of the first column (e.g. opposite to the left side relative to the upper electrode 1120), and the third column connection line 1170 is positioned on the left side of the first column. As in the illustrated embodiment, the column connection lines 1170 connecting the upper electrodes 1120 in all odd-numbered columns are preferably arranged in the same manner as the first column, and the column connection lines 1170 connecting the upper electrodes 1120 in all even-numbered columns are preferably arranged in an opposite manner to the first column. In other words, the arrangement pattern of the column connection lines 1170 from column to column alternates.

The first conductive line 1150 connecting a column of upper electrodes 1120 to the column control unit 1210 is disposed following the alternating pattern of the first column connection lines 1170. As illustrated in FIGS. 14 and 15, the first column connection line 1170 closest to the column control unit 1210 for each column is disposed on an opposite side as the first conductive line 1150 for that column. The first conductive line 1150 and the plurality of first column connection lines 1170 within each column may be collectively referred to as a first connection member.

In addition, as shown in FIGS. 14 and 15, four lower electrodes 1130 in a first row are connected in series through three row connection lines 1180, the first row being the uppermost row in FIG. 15. First and third row connection lines 1180 (e.g., taken from the row control unit 1220) are preferably positioned on the lower sides of the first row, and the second row connection line 1180 is positioned on the upper side of the first row. As in the illustrated embodiments, the row connection lines 1180 connecting the lower electrodes 1130 in all odd-numbered rows are preferably arranged in the same manner as the first row, and the row connection lines 1180 connecting the lower electrodes 1130 in even-numbered rows are preferably arranged in an opposite manner to the first row. In other words, the arrangement pattern of the row connection lines 1180 from row to row alternates.

The second conductive line 1160 connecting a row of lower electrodes 1130 to the row control unit 1220 is disposed following the alternating pattern of the second column connection lines 1180. As illustrated in FIGS. 14 and 15, the second column connection line 1180 closest to the row control unit 1220 for each row is disposed on an opposite side as the second conductive line 1160 for that column. The second conductive line 1160 and the plurality of second column connection lines 1180 within each row may be collectively referred to as a second connection member.

Advantageously, in the illustrated embodiment, the column connection lines 1170 and the row connection lines 1180 are arranged so that they do not overlap each other, thereby minimizing the discharge interference caused by overlapping of the connection lines.

As described above, according to the exemplary embodiments of the present invention, a plurality of light source unit rows or columns successively emit light for one frame, thereby reducing power consumption.

In addition, according to the exemplary embodiments of the present invention, the brightness of light is controlled according to images provided to a display panel by individually driving a plurality of light source units in the light source unit rows or columns, so that a contrast ratio of the image can be improved and power consumption can also be considerably reduced.

Moreover, according to the exemplary embodiments of the present invention, inverters respectively connected to light source unit rows or columns cause a plurality of light source units in the light source unit rows or columns to emit light. Therefore, the number of the inverters for causing light source units to emit light can be reduced to thereby cut down a manufacturing cost.

Further, according to the exemplary embodiments of the present invention, upper and lower electrodes are formed in an island shape on the upper and lower sides of light source units, thereby preventing discharge interference between adjacent light source units.

Furthermore, according to the exemplary embodiments of the present invention, upper electrodes in column directions are connected through column connection lines, and lower electrodes in row directions are connected through row connection lines, where the column connection lines and the row connection lines do not overlap each other. Advantageously, the discharge interference between adjacent light source units can be prevented.

Although the present invention has been described in connection with the accompanying drawings and the exemplary embodiments, the present invention is not limited thereto but defined by the appended claims. Accordingly, it will be understood by those skilled in the art that various modifications and changes can be made thereto without departing from the spirit and scope of the invention defined by the appended claims.

What is claimed is:

1. A light source module, comprising:
a plurality of light source units arranged substantially in a matrix form and independently emitting light; and
a light source control unit including:
a column control unit supplying a column control signal to each of a plurality of light source unit columns according to a brightness signal,
a row control unit supplying a row control signal to each of a plurality of light source unit rows according to the brightness signal, and
a brightness regulation unit supplying the brightness signal to the column control unit and the row control unit,
wherein the plurality of light source units successively emit light for one frame in one of a light source unit column direction and a light source unit row direction according to the brightness signal, the column control signal and the row control signal.

2. The light source module as claimed in claim 1, wherein the column control signal is successively supplied to the plurality of light source unit columns, and the row control signal is supplied to the plurality of light source unit rows at substantially the same time, or the column control signal is supplied to the plurality of light source unit columns at substantially the same time, and the row control signal is successively supplied to the plurality of light source unit rows.

3. The light source module as claimed in claim 1, wherein each of the plurality of light source units comprises a positive terminal, a negative terminal, and a light source emitting light according to a voltage difference between the positive and negative terminals, and
wherein the positive terminals of the light source units within each light source unit column are electrically connected to each other, and the negative terminals of the light source units within each light source unit row are electrically connected to each other.

4. The light source module as claimed in claim 3, further comprising a plurality of column control lines connecting the positive terminals of the respective light source unit columns to the column control unit, and a plurality of row control lines connecting the negative terminals of the respective light source unit rows to the row control unit.

5. The light source module as claimed in claim 4, wherein
the plurality of column control lines comprises:
a plurality of column extension lines connected to the column control unit and extending in column directions, and
a plurality of column connection lines connecting the positive terminals in the light source unit columns to the column extension lines; and
the plurality of row control lines comprises:
a plurality of row extension lines connected to the row control unit and extending in row directions, and
a plurality of row connection lines connecting the negative terminals in the light source unit rows to the row extension lines.

6. The light source module as claimed in claim 4, wherein
the plurality of column control lines comprises a plurality of column connection lines connecting adjacent positive terminals to each other in the light source unit columns, and
the plurality of row control lines comprises a plurality of row connection lines connecting adjacent negative terminals to each other in the light source unit rows.

7. The light source module as claimed in claim 4, wherein the column control unit comprises a plurality of column inverters respectively connected to the plurality of column control lines, and the row control unit comprises a plurality of row inverters respectively connected to the plurality of row control lines.

8. The light source module as claimed in claim 1, wherein the light source unit is selected from the group consisting of a light emitting diode and a xenon lamp.

9. A light source module, comprising:
a light source unit including:
a light emission plate including a plurality of discharge regions arranged substantially in a matrix form and separated from each other,
a plurality of upper electrodes disposed at a first side of the light emission plate and corresponding to the discharge regions, and
a plurality of lower electrodes disposed at a second side of the light emission plate and corresponding to the discharge regions, the second side being opposite to the first side relative to the light emission plate,
wherein the upper electrodes are electrically connected in a plurality of upper electrode columns extending in a column direction of the discharge regions, and the lower electrodes are electrically connected in a plurality of lower electrode rows extending in a row direction of the discharge regions, the row direction being transverse to the column direction; and
a light source control unit supplying a column control signal to each upper electrode column including the upper electrodes connected in the column direction, and supplying a row control signal to each lower electrode row including the lower electrodes connected in the row direction.

10. The light source module as claimed in claim 9,
wherein each of the plurality of upper electrodes is disposed on a top surface of the light emission plate corresponding to the discharge regions, each upper electrode column including more than one upper electrode arranged in the column direction, and the more than one upper electrode being separated from each other, and
wherein each of the plurality of lower electrodes is disposed on a bottom surface of the light emission plate corresponding to the discharge regions, each lower electrode row including more than one lower electrode arranged in the row direction, and the more than one lower electrode being separated from each other.

11. The light source module as claimed in claim 10, wherein a plane size of each of the upper electrodes and the lower electrodes is equal to or smaller than a plane size of the discharge region.

12. The light source module as claimed in claim 10, wherein the light source unit further comprises a plurality of column control lines electrically connecting the upper electrodes in each upper electrode column, and a plurality of row control lines electrically connecting the lower electrodes in each lower electrode row.

13. The light source module as claimed in claim 12, wherein the plurality of discharge regions are separated from each other by a row separation space extended in the row direction, and a column separation space extended in the column direction, and a portion of the column control lines and a portion of the row control lines is positioned in the row separation space or the column separation space, and only one of the column control lines and the row control lines is positioned in an intersection region of the column separation space and the row separation space.

14. The light source module as claimed in claim 12, wherein
each of the column control lines comprises:
a column extension line extending in the column direction, and
a plurality of column connection lines connecting the column extension line to the upper electrodes in the upper electrode column; and
each of the row control lines comprises:
a row extension line extending in the row direction, and
a plurality of row connection lines connecting the row extension line to the lower electrodes in the lower electrode row.

15. The light source module as claimed in claim 12, wherein each of the column control lines comprises a plurality of column connection lines connecting adjacent upper electrodes in the column direction, and each of the row control lines comprises a plurality of row connection lines connecting adjacent lower electrodes in the row direction.

16. The light source module as claimed in claim 15, wherein the plurality of column connection lines are arranged in a zigzag pattern in a plane view with respect to the upper electrodes adjacent to each other in the column direction, the plurality of row connection lines are arranged in a zigzag pattern in the plane view with respect to the lower electrodes adjacent to each other in the row direction, and the plurality of column connection lines and the plurality of row connection lines do not overlap each other in the plane view.

17. The light source module as claimed in claim 9, wherein the light emission plate comprises:
an upper substrate;
a lower substrate; and
a separation wall disposed between the upper substrate and the lower substrate, and separating the discharge regions from each other, the discharge regions including a discharge gas disposed therein, the discharge gas being one of Hg, Ne and Xe.

18. The light source module as claimed in claim 9, wherein
each of the plurality of upper electrodes is disposed on a top surface of the light emission plate, each upper electrode column including only one upper electrode extending lengthwise in the column direction of the discharge regions, and
each of the plurality of lower electrodes is disposed on a bottom surface of the light emission plate corresponding to the discharge regions, each lower electrode row including more than one lower electrode arranged in the row direction, and the more than one lower electrode being separated from each other.

19. A display device, comprising:
a display panel including an image display region displaying images according to an image signal, the image display region being divided into a plurality of display regions; and
a light source module including:
a plurality of light source units arranged substantially in a matrix form corresponding to the display regions, respectively, the light source units emitting light having luminance independently varied according to brightness of the corresponding display regions, and
a light source control unit supplying a control signal controlling the luminance of the light source units to light source unit columns and light source unit rows,
wherein a first electrode terminal of each of the light source units in each of the light source unit columns are electrically connected to each other, a second electrode terminal of each of the light source units in each of the light source unit rows are electrically connected to each other, and
wherein the light source control unit comprises a column control unit supplying a corresponding column control signal to the first electrode terminals of each light source unit column, and a row control unit supplying a corresponding row control signal to the second electrode terminals of each light source unit row.

20. The display device as claimed in claim 19, wherein the light source control unit further comprises:
a brightness regulation unit supplying a brightness signal to the column control unit and the row control unit according to the brightness of the corresponding display regions, and
the light source unit columns or the light source unit rows successively emit light for one frame according to the brightness signal, the column control signal and the row control signal.
